(19) United States
(12) Patent Application Publication
(10) Pub. No.: US 2013/0227711 A1
(43) Pub. Date: Aug. 29, 2013

(54) Controlled Access by Applications to Mobile Device Resources

(71) Applicant: Smith Micro Software, Inc., (US)

(72) Inventors: Ryan MacPherson, Decatur, GA (US); Jian Chen, Cupertino, CA (US)

(73) Assignee: Smith Micro Software, Inc., Aliso Viejo, CA (US)

(21) Appl. No.: 13/776,174

(22) Filed: Feb. 25, 2013

Related U.S. Application Data
(60) Provisional application No. 61/605,080, filed on Feb. 29, 2012.

(51) Int. Cl. G06F 21/62

(52) U.S. Cl. CPC G06F 21/62
USPC 726/29

(57) ABSTRACT

There is provided a system and method for controlled access by applications to mobile device resources. The method comprises receiving a request from one of a plurality of applications to access a first resource of a plurality of resources, determining whether the first resource of the plurality of resources is classified as a protected resource, if the determining determines that the first resource of the plurality of resources is classified as the protected resource, identifying an application authorization for the first resource, and configuring access by the one of the plurality of applications to the first resource according to the application authorization. Based on the application authorization, the method may further configure access by the one of the plurality of applications to a second resource of the plurality of resources. Additionally, the first resource of the plurality of resources may be connected to a communication network resource.

### RELATED APPLICATIONS

This application claims priority of U.S. Provisional Application No. 61/605,080 filed on Feb. 29, 2012, which is hereby incorporated by reference in its entirety.

### BACKGROUND

Mobile device applications have become a focus for application design and innovation. Open and customizable mobile device platforms enable third party application designers to create and distribute general and specialized applications. Thus, communication network operators and device manufacturers have an increasingly smaller amount of control over how the applications are created, distributed, and used. While this has encouraged innovation, accountability in application use and control has not been strictly maintained. Furthermore, as mobile devices become more advanced, these applications increasingly use the mobile device and network resources.

Due to the lack of control over application creation and use, serious risks to mobile devices and communication networks arise. Applications may unintentionally or even purposely misuse device and/or network resources. For example, applications may improperly use device resources, such as a battery, CPU, and/or memory. This can cause significant performance problems and potentially compromise device security. Additionally, applications may misuse communication network resources. A rogue application may intentionally or accidentally consume network data resources and have adverse effects on both the device's user and the network operator. Applications may bypass network entitlements and thus cause violations of network terms of services. Current preventative and reactive approaches may help in certain instances, but they are often insufficient to adequately cover the expanding mobile device application field.

### SUMMARY

The present disclosure is directed to controlled access by applications to mobile device resources, substantially as shown in and/or described in connection with at least one of the figures, as set forth more completely in the claims.

### BRIEF DESCRIPTION OF THE DRAWINGS

FIG. 1 presents an exemplary system environment for controlling access by applications to mobile device resources;

FIG. 2 shows a user device for controlling access by application to mobile device resources;

FIG. 3 shows an exemplary application policy management and enforcement process running on a mobile device for controlling access by applications to mobile device resources; and

FIG. 4 presents an exemplary flowchart illustrating a method for controlling access by application to mobile device resources.

### DETAILED DESCRIPTION

The following description contains specific information pertaining to implementations in the present disclosure. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

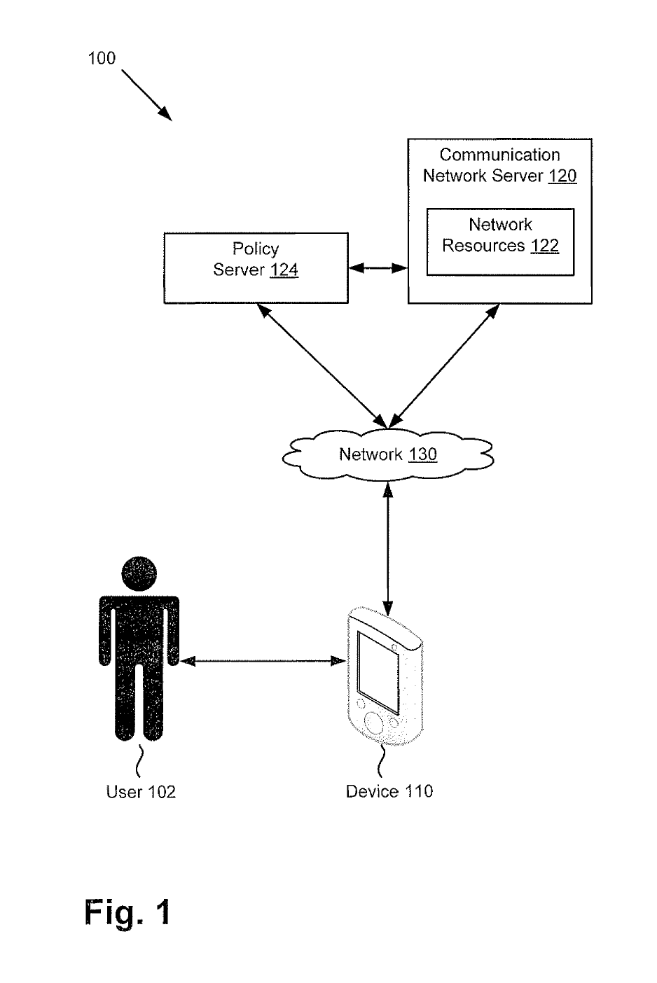

FIG. 1 presents an exemplary system environment for controlling access by applications to mobile device resources. According to FIG. 1, system environment 100 includes user 102 utilizing device 110. Device 110 is further connected to communication network server 120 over network 130. Communication network server 120 contains network resources 122. Further shown in FIG. 1 is policy server 124 in communication with communication network server 120 and device 110 over network 130.

As shown in FIG. 1, user 102 may utilize device 110. Device 110 may include a processor and memory for use in downloading and running one or a plurality of device applications. For example, user 102 may download applications and run the applications on device 110. User 102 may download the applications to device 110 over network 130 or through user input, such as a connection to another device and/or memory unit, such as a personal computer, an external hard drive, USB flash drive, or other memory unit. Although in the implementation of FIG. 1, device 110 is shown as a personal mobile device, device 110 may be any suitable user device, such as a mobile phone, a personal computer (PC) or other home computer, a personal digital assistant (PDA), a television receiver, or a gaining console, for example.

Device 110 is shown connected to communication network server 120 over network 130. Communication network server 120 may correspond to a server available over network 130 to device 110 including application policies, updates, communication network resources, and other processes and features for controlling access by applications to device and/or network resources. Communication network server 120 may contain databases and memory for storage of policies, updates, application and device analytics, and other relevant data. Communication network server 120 may also contain processors capable of performing the processes required by communication network server 120. While communication network server 120 is shown as one server, it is understood that communication network server 120 may correspond to one server or a plurality of servers.

Communication network server 120 includes network resources 122. Network resources 122 may correspond to access to network components, such as radio access network resources, core network resources, wireless spectrum, and/or other network components. Network resources 122 may be universal or specific to device 110. For example, network resources 122 may correspond to data transfer speeds and consumption limits. Thus, device 110 may be limited to certain data consumption plans and/or features based on network resources 122.

Communication network server 120 is shown in communication with policy server 124. Policy server 124 may correspond to a push and/or pull mechanism including necessary processors and memory, for enforcing policy rules necessary to control access by applications to device and/or network resources. Thus, policy server 124 may include policy rules determining what applications are given access to device and/or network resources, as well as the level of access. Furthermore, policy server 124 may include a policy editor and/or policy updater necessary for changing application access. Policy server 124 may include an analytic function for receiving and processing analytics corresponding to device applications. While policy server 124 is shown separate from communication network server 120, in other implementations policy server 124 may be part of or reside within communication network server 120.

Device 110 is connected to communication network server 120 over network 130. Network 130 may correspond to a network connection, such as a wireless phone service communication network, broadband network, or other network capable of sending of receiving data. Network 130 may allow for user 102 to utilize device 110 to transmit and receive data.

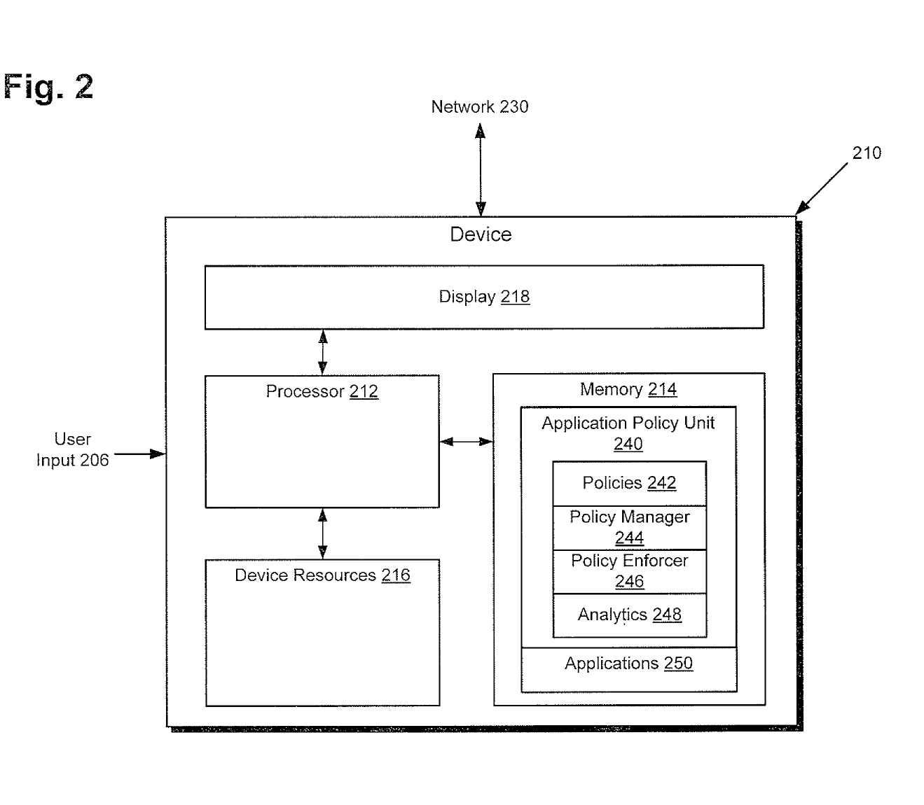

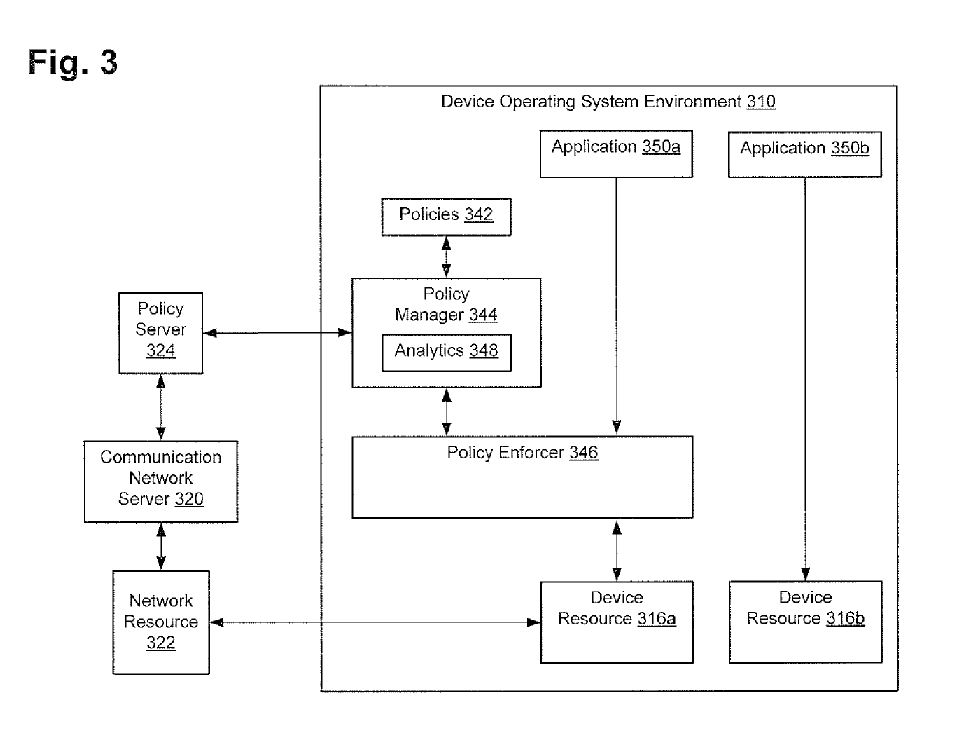

User 102 may utilize an application on device 110. In cases where the application is given unlimited access to device and/or network resources, the application may over consume the resource. For example, an application utilizing excessive signaling may cause performance degradation; while excessive data consumption may adversely effect data plan limits of user 102. However, as will be discussed further in reference to FIGS. 2 and 3, device 110 of FIG. 1 includes an application policy unit with managed and enforced policies to control and/or limit application access to device and/or network resources. Thus, the application may be limited to consuming only a certain amount of the resource or may be barred from utilizing the resource. A policy manager and enforcer may prevent excessive consumption of device and network resources, thereby preventing performance degradations and violations of terms of services and accepted use policies.

Moving to FIG. 2, FIG. 2 shows a user device for controlling access by application to mobile device resources. FIG. 2 shows device 210 including processor 212, memory 214, device resources 216, and display 218. Including in memory 214 is application policy unit 240 having policies 242, policy manager 244, policy enforcer 246, and analytics 248. Memory 214 of device 210 also includes applications 250. Device 210 receives user input 206 and is connected to network 230.

According to FIG. 2, device 210 includes processor 212 and memory 214. Processor 212 of FIG. 2 is configured to access memory 214 to store received input and/or to execute commands, processes, or programs stored in memory 214. Processor 212 may also access memory 214 and execute processes stored in memory 214. For example, processor 212 running application policy unit 240 may determine analytics 248 corresponding to an application and store as analytics 248 memory 214. Processor 212 may also utilize policy manager 244 and policy enforcer 246 of application policy unit 240 and/or applications 250 stored in memory 214. Processor 212 may correspond to a processing device, such as a microprocessor or similar hardware processing device, or a plurality of hardware devices. However, in other implementations, processor 212 refers to a general processor capable of performing the functions required by device 210. Memory 214 is a sufficient memory capable of storing commands, processes, and programs for execution by processor 212. Memory 214 may be instituted as ROM, RAM, flash memory, or any sufficient memory capable of storing a set of commands. In other implementations, memory 214 may correspond to a plurality of memory types or modules. Thus, processor 212 and memory 214 contains sufficient memory and processing units necessary for device 210. Although memory 214 is shown as located on device 210, in other implementations, memory 214 may be separate but connectable to device 210.

Memory 214 of FIG. 2 is shown containing application policy unit 240 having policies 242, policy manager 244, policy enforcer 246, and analytics 248. Application policy unit may correspond to a customized access control system. Application policy unit 240 may give a communication network operator, device original equipment manufacturer, or other authorized party, policy-based control over application access to device and/or network resources. Policies 242 may designate device access to specific device and/or network resources. For example, policies 242 may dictate that specific device and/or network resources be protected by specific use and access policies. In such a mandatory or non-discretionary access control security, applications and users may not override policy decisions that limit access and use of designated device and network resources. Thus, policies 242 may prevent overuse or access to certain device and/or network resources depending on the user, application, and/or resource.

Policies 242 may also designate other device and/or network resources to be given a discretionary access control. Certain device and/or network resources will be assigned application access and use by an administrator. Thus, device and/or network resources designated in policies 242 may allow application access to be assigned by users. Policies 242 may be defined by a single application or group of applications. Policies 242 contains information necessary to identity restricted access by an application. Thus, policies 242 may contain package, process, and application identifiers as well as device and/or network resource identifiers. Policies 242 may also contain actions performed by policy manager 244 when restricted access is detected, such as launching another application, enabling access to a different resource, modifying the resource access entitlement, recording analytics 248, displaying an advertisement for increased network resource entitlement or mobile device application, or other designated action.

In order to utilize policies 242, application policy unit 240 also contains policy manager 244 and policy enforcer 246. Policy manager 244 may correspond to a component running in a user space of the device operating system of device 210 that loads, interprets, executes, and updates policies 242. Thus, policy manager 244 may read policies 242 in memory 214, update policies 242 when required, and respond to requests from policy enforcer 246 when access to device and/or network resources are requested. Policy manager 244 may also verify entitlement to resources of current and running applications and store results as analytics 248 for data processing and/or policy updates by an outside server.

Application policy unit 240 of FIG. 2 further contains policy enforcer 246. Policy enforcer 246 may correspond to a kernel module in the kernel space of the device operating system. Policy enforcer 246 may communicate with policy manager 244 in order to enforce access control by applications run in the user space to protected device and/or network resources. Policy enforcer 246 may start other access control components at device boot/startup or as needed. Policy enforcer 246 is utilized whenever a application attempts to access a device and/or network resource protected by policy enforcer 246.

Application policy unit 240 further contains analytics 248. Analytics may correspond to a set of information containing application access requests, device resource use, device conditions, or other data relevant to application access to protected device and/or network resources. Application policy unit 240 may transmit analytics 248 over network 230 to a server, such as a communication network server, analytics server, or other server, for analysis of analytics 248. Analytics 248 may be used to change and adapt policies 242 for changing device and/or network resources. Analytics 248 may also be used to determine the effectiveness of current use policies in policies 242. Further, analytics 242 may also be used by application designers in order to tune and adjust their applications for better and more efficient device use or to comply with policies 242.

Memory 214 of device 210 further includes applications 250. Applications 250 may correspond to device applications and processes that a user may install and run on device 210. Applications 250 may be downloaded over network 230 or installed by a user through user input 206. As previously discussed, network 230 may correspond to a communication network, such as a wireless phone service communication network, broadband network, or other network capable of sending of receiving data. User input 206 may correspond to a connection to another device and/or memory unit, such as a personal computer, an external hard drive, USB flash drive, or other memory unit.

Device 210 of FIG. 2 further includes device resources 216. Device resources 216 may include mobile device resources and connected network resources. For example, current mobile devices, such as device 210, include a battery, processing unit such as a CPU, memory units, and radios. Device resources 216 may also include network resources connected to device resources, such as radio access network resources, bandwidth, wireless spectrum, or other network resources. Network resources may also be general or specific to device 210, such as data plans including specific data use thresholds, speeds and types of data exchange.

Device 210 is also shown with display 218 connected to processor 212. Display 218 may correspond to a visual display unit capable of displaying application interfaces to a user. Display 218 may correspond to a liquid crystal display, plasma display panel, cathode ray tube, or other display. Processor 212 is configured to access display 218 in order to display application interfaces for use. For example, display 218 may present an interface for application policy unit 240. Additionally, display 218 may render and display content, such as advertisements and notifications from policies 242. While FIG. 2 shows display 218 as part of device 210, in other implementations, display 218 may be external to device 210 or separate and connectable to device 210. Thus, in certain implementations, such as when device 210 is a television receiver, display 218 may be separate and connectable to device 210. Additionally, display 218 may correspond to one visual display unit or a plurality of visual display units

Moving to FIG. 3, FIG. 3 shows an exemplary application policy management and enforcement process running on a mobile device for controlling access by applications to mobile device resources. FIG. 3 shows device operating system environment 310. Included in device operating system environment 310 are application 350a, application 350b, policies 342, policy manager 344 having analytics 348, policy enforcer 346, device resource 316a, and device resource 316b. Further shown in FIG. 3 is policy server 324 in communication with policy manager 344 and communication network server 320. Also shown in FIG. 3 is network resource 322 in connection with device resource 316a and communication network server 320.

According to FIG. 3, may include application 350a and application 350b. As previously discussed, the applications may correspond to mobile device applications and processes that utilize device and/or network resources. For example, a device may require data consumption or wireless signaling. As can be seen in FIG. 3, application 350a is attempting to access device resource 316a, which is connected to network resource 322. Also shown in FIG. 3, application 350b is attempting to access device resource 316b.

As seen in FIG. 3, device operating system environment 310 runs an application policy management and enforcement process. In the example of FIG. 3, certain device resources and network resources are protected from access by policies established in policies 342. Policies 342 may include access policies that govern the access and use of device and/or network resources. Policies 342 may define the policies for access to protected device resources, such as device resource 316a. Policies 342 contain the detection rules used to evaluate access to device resource 316a and the corresponding actions to be taken for the access request. As previously discussed, policy enforcer 346 may be run in the kernel space and protect device resources 316a and 316b. As shown in FIG. 3, policy enforcer 345 prevents access by application 350a to device resource 316a. However, policy enforcer 346 does not block access to device resource 316b by application 350b. Thus, as established by policies 342, application 350b may freely access device resource 350b, however application 350a must receive appropriate access by policy enforcer 346 to device resource 316a, and therefore network resource 322.

When application 350a requests access to device resource 316a, policy enforcer 346 enforces policy control over protected device resource 316a. Thus, when policy enforcer 346 intercepts access requests to device resource 316a, policy enforcer 346 will send appropriate information to policy manager 344 in order to determine the appropriate access level of application 350a to device resource 316a. Policy enforcer 346 may inform policy manager 344 of the process and application identifiers as well as the device and network resource requested.

Policy manager 344 may be run in the native user space of device operating system environment 310. Policy manager 344 may load, interpret, and execute the access control policies in policies 342. As shown in FIG. 3, policy manager 344 is in communication with policy enforcer 346 and enforces policies 344. Thus, when policy enforcer 346 transmits information corresponding to an access control request by application 350a to device resource 316a, policy manager 344 may read policies 342 and execute the appropriate enforcement action. For example, if application 350a is denied access or given limited access to device resource 316a, policy manager 344 may configure access to device resource 316a with policy enforcer 346. Additionally, policy manager 344 may take other appropriate actions, such as generating a notification for the user or displaying advertisements for additional access to device resource 316a.

Device resource 316a is further connected to network resource 322. Device resource 316a and network resource 322 may correspond to the appropriate radio and data transfer function of a communication network. Network resource 322 is further connected to communication network server 320, such as a wireless communication network server. Thus, in the implementation of FIG. 3, access to device resource 316a and thus network resource 324 is governed by policy enforcer 346 with policy manager 344 enforcing policies 342.

Also shown in policy manager 344 of FIG. 3 is analytics 348. As previously discussed, analytics 348 may correspond to application use and access request data. Thus, policy enforcement results and device and/or network resource consumption may be aggregated by policy manager 344.

Policy manager 344 is shown in communication with policy server 324. Thus, policy manager 344 may transmit analytics 348 to policy server 324. Analytics 348 may then be used by policy server 324 to update policies 342, analyze device and network resource consumption, and provide historical data to communication network server 320. Analytics 348 may also be used to provide targeted content and/or advertisement by communication network server 320 to specific users depending on device and/or network resource consumption.

As previously discussed, device resource 316b is not a protected resource under policies 342. Thus, as can be seen in FIG. 3, application 350b may be given free access to device resource 316b. However, users or an administrator may also set application access limitations or preventions. Thus, application 350b may be separately given limited access or denied access to device resource 316b.

In order to prevent unauthorized access to device resource 316a, policy enforcer 346 may be configured to prevent access to device resource 316a if it does not receive access information from policy manager 344. Thus, policy enforcer 346 may be configured to always deny access in cases where policy manager 344 is compromised. Policy enforcer 346 may also use data security techniques, such as digital signatures, to ensure the integrity of policy manager 344 and policies 342. Additionally, policy manager 344 may be configured to send periodic “heartbeat messages,” or policy manager status messages to policy server 324. As policy server 324 is either in communication with or resides on communication network server 320, if policy server 324 does not receive a “heartbeat message” when a specific network resource is requested, communication network server 320 may prevent access to network resource 322 by device resource 316a.

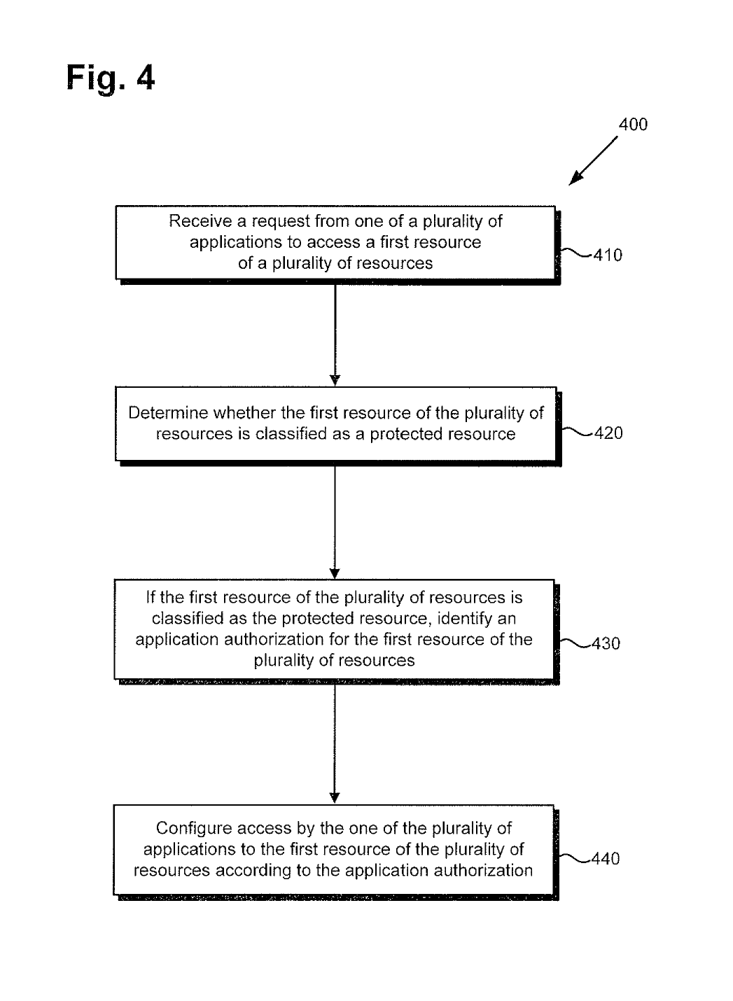

FIGS. 1, 2, and 3 will now be further described by reference to FIG. 4, which presents flowchart 400 illustrating a method for controlling access by application to mobile device resources. With respect to the method outlined in FIG. 4, it is noted that certain details and features have been left out of flowchart 400 in order not to obscure the discussion of the inventive features in the present application.

Referring to FIG. 4 in combination with FIG. 1, FIG. 2, and FIG. 3, flowchart 4 begins with receiving a request from one 350a/350b of a plurality of applications 250 to access a first resource 316a/316b/324 of a plurality of resources 124/216 (410). The receiving may be performed by processor 212 of device 110/210 running policy enforcer 246/346 after receiving an access request from one of application 350a/350b of applications 250. The access request may correspond to a request to access one 316a/316b of device resources 216, or network resource 322 of network resources 122.

Flowchart 400 continues with determining whether the first resource 316a/316b/324 of the plurality of resources 124/216 is classified as a protected resource 316a (420). The determining may be performed by processor 212 of device 110/210 running policy enforcer 246/346. The determining may be clone by policy enforcer 246/346 after receiving the request to access device resource 316a/316b. Policy enforcer 246/346 may determine device resource 316a is classified as protected, while device resource 316b is unprotected.

Policy enforcer 246/346 may be called by the device kernel when application 350a attempts to access protected resources 316a. After determining resource 316a is protected, identifying information of application 350a may be sent to policy manager 244/344. However, if application 350b attempts to access unprotected resource 316b, policy enforcer 246/346 is not utilized and the application 350b is given access to device resource 316b, pending any system administrator access controls.

The method of flowchart 400 continues with if the first resource 316a/316b/324 of the plurality of resources 124/216 is classified as the protected resource 316a, identifying an application authorization for the first resource 316a of the plurality of resources 124/216 (430). Processor 212 of device 110/210 may perform the identifying by running policy manager 244/344 and utilizing policies defined in policies 242/342. As previously discussed, policy manager 244/344 may be a component running in the device user space of device operating system environment 310. Policy manager 244/344 may be responsible for checking policies 242/342 and identifying an application authorization for application 350a to device resource 316a. The application authorization may include permission to access device resource 316a, access level to device resource 316a, and/or permission and access to network resource 322.

Policy enforcer 346 may communicate application identifiers to application 350a when intercepting an access request to device resource 316a. Thus, policy manager 244/344 may have access to application identifiers and corresponding requests to device resource 316a. Policy manager 244/344 may check policies 242/342 to determine the application authorization to device resource 316a and may also save and transmit access request information and application information as analytics 248/348. Policies 242/342 may be a defined by a single application or group of applications and may exist as a file that is encrypted and digitally signed for confidentiality and integrity.

Flowchart 400 continues with configuring access by the one 350a of the plurality of applications 250 to the first resource 316a of the plurality of resources 124/216 according to the application authorization (440). The configuring may be performed by processor 212 of device 110/210 running policy manager 244/344. Policy manager 244/344 may determine an application authorization for application 350a using policies 242/342. After determining the application authorization, policy manager 244/344 may instruct policy enforcer 246/346 to configure access to device resource 316a and/or network resource 322 based on policies 242/342.

Thus, using the above description, controlled access by applications to mobile device resources may be more easily enforced. Using the above implementations gives a strong yet flexible resource by device manufacturers and communication network operators to control valuable resources. This allows users to configure access to basic device and network resources while preventing possible overuse and breaches of terms of service and/or accepted use policies.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A method of controlling access by a plurality of applications running on a mobile device to a plurality of resources provided by the mobile device, the method comprising:
receiving a request from one of the plurality of applications to access a first resource of the plurality of resources;
determining whether the first resource of the plurality of resources is classified as a protected resource;
if the determining determines that the first resource of the plurality of resources is classified as the protected resource, identifying an application authorization for the first resource of the plurality of resources; and
configuring access by the one of the plurality of applications to the first resource of the plurality of resources according to the application authorization.

2. The method of claim 1 further comprising:
configuring access by the one of the plurality of applications to a second resource of the plurality of resources according to the application authorization.

3. The method of claim 1, wherein the first resource of the plurality of resources is a communication network resource.

4. The method of claim 3 further comprising:
displaying an advertisement corresponding to the communication network resource.

5. The method of claim 1 further comprising:
transmitting analytics corresponding to the one of the plurality of applications to a policy server.

6. The method of claim 5, wherein the analytics are used to update the application authorization.

7. The method of claim 1 further comprising:
transmitting a policy manager status message to a policy server.

8. The method of claim 1 further comprising:
altering the application authorization using a policy editor.

9. A mobile device for controlling access to mobile device resources, the mobile device comprising:
the processor configured to:
receive a request from one of the plurality of applications to access a first resource of the plurality of resources;
determine whether the first resource of the plurality of resources is classified as a protected resource;
if the processor determines that the first resource of the plurality of resources is classified as the protected resource, the processor further configured to:
identify an application authorization for the first resource of the plurality of resources; and
configure access by the one of the plurality of applications to the first resource of the plurality of resources according to the application authorization.

10. The mobile device of claim 9 wherein the processor is further configured to:
configure access by the one of the plurality of applications to a second resource of the plurality of resources using the application authorization.

11. The mobile device of claim 9, wherein the first resource of the plurality of resources is a communication network resource.

12. The mobile device of claim 11, wherein the processor is further configured to:
display an advertisement corresponding to the communication network resource.

13. The mobile device of claim 9, wherein the processor is further configured to:
transmit analytics corresponding to the one of the plurality of applications to a policy server.

14. The mobile device of claim 13, wherein the analytics are used to update the application authorization.

15. The mobile device of claim 9, wherein the processor is further configured to:
transmit a policy manager status message to a policy server.

16. The mobile device of claim 9, wherein the processor is further configured to:
alter the application authorization using a policy editor.

17. A method for displaying a user interface for use with a device, the method comprising:
receiving a request from one of the plurality of applications to access a first resource of the plurality of resources;
determining whether the first resource of the plurality of resources is classified as a protected resource;
if the determining determines that the first resource of the plurality of resources is classified as the protected resource, identifying an application authorization for the first resource of the plurality of resources; and
display the application authorization for the first resource of the plurality of resources.

18. The method of claim 17, wherein the first resource of the plurality of resources is a communication network resource.

19. The method of claim 18, further comprising:
displaying an advertisement corresponding to the communication network resource.

20. The method of claim 17 further comprising:
displaying an alert corresponding to the application authorization.
